(19) United States
(12) Patent Application Publication
(10) Pub. No.: US 2007/0279383 A1
(43) Pub. Date: Dec. 6, 2007

(54) COMPUTER MOUSE COVER

(76) Inventor: Brian McCracken, San Clemente, CA (US)

Correspondence Address: DOVAS LAW P.C., 307 BAINBRIDGE STREET, PHILADELPHIA, PA, 19147, US

(21) Appl. No.: 11/754,996

(22) Filed: May 29, 2007

Related U.S. Application Data
(60) Provisional application No. 60/803,857, filed on Jun. 3, 2006.

(51) Int. Cl. G09G 5/08

(52) U.S. Cl. 345/163

(57) ABSTRACT

A cover for covering a computer mouse is provided. The cover includes a chassis which defines a mouse receiving area and a shell connected to the chassis further defining the mouse receiving area. The shell includes a moveable touch area for contacting a first control portion of the computer mouse and an aperture for allowing access to a second control portion of the computer mouse. The present invention also provides a combination mouse cover and computer mouse, and further provides a method for modifying an external form of a computer mouse.

### CROSS REFERENCE TO RELATED APPLICATION(S)

This application claims the benefit of U.S. provisional application No. 60/803,857, filed Jun. 3, 2006, which is incorporated by reference as if fully set forth.

### BACKGROUND

The computer mouse, a hand-operated electronic pointing and selecting device, has become a necessary component of the modern personal computer. Since nearly all personal computing software applications benefit from user inputs from a pointing and selecting device, most personal computer users presently use a mouse for interacting with a computer display. The modern mouse typically includes a bottom-mounted optical sensor or track ball for tracking, top-mounted push buttons for selecting, and a top-mounted wheel or other control device for scrolling. In many cases, lighted indicia are included to provide operation status or other information.

While computer mice have become ubiquitous in the world of personal computing, most commercially available mice possess the same basic external form and features, often with little variation among them. Since commercially available mice are often produced in a form which is a compromise to satisfy the average computer user, many less average users are unable to find a mouse which can satisfy their needs for a comfortable, durable or aesthetically pleasing device. More often than not, different users have different personal preferences or requirements with regard to the size, shape, and durability of their computer mouse. A computer user wishing to own a mouse which incorporates the latest electronics or other special internal features may be especially limited with respect to choice of size and overall external form of the device.

It would be desirable to provide a cover which can change the external form of a computer mouse while retaining the functionality of all of the features of the mouse. While mouse covers are known, none of the known covers are capable of changing the external form of a mouse while allowing all of the features of the typical mouse to be used as originally intended.

### SUMMARY

The present invention provides a cover for covering a computer mouse. The cover includes a chassis which defines a mouse receiving area and a shell connected to the chassis further defining the mouse receiving area. The shell includes a moveable touch area for contacting a first control portion of the computer mouse and an aperture for allowing access to a second control portion of the computer mouse.

The present invention further provides a combination mouse cover and computer mouse. The combination includes a computer mouse with two control portions and a mouse cover connected to the computer mouse which at least partially conceals the computer mouse. The mouse cover includes a moveable touch area in contact with one of the control portions and an aperture for allowing access to another one of the control portions.

The present invention further provides a method for modifying an external form of a computer mouse. The method includes providing a computer mouse with two control portions. A cover is provided having a touch area and an access aperture. The cover is connected to the mouse, wherein the touch area is aligned to one of the control portions, and wherein the access aperture is aligned to another one of the control portions.

### BRIEF DESCRIPTION OF THE DRAWINGS

The following detailed description will be readily understood in conjunction with the appended drawings which illustrate preferred embodiments of the invention. In the drawings:

FIG. 1 is a top perspective view of a mouse cover in accordance with a first preferred embodiment of the present invention.

FIG. 2 is a bottom perspective view of the mouse cover of FIG. 1.

FIG. 3 is an exploded bottom perspective view of the mouse cover of FIG. 1.

FIG. 4 is an exploded side elevation view of the mouse cover of FIG. 1, shown with a mouse.

FIG. 5 is an exploded top perspective view of the mouse cover of FIG. 1, shown with a mouse.

FIG. 6 is rear elevation view of the mouse cover of FIG. 1, with a mouse covered thereby.

FIG. 7 is a front elevation view of the mouse cover of FIG. 1, with a mouse covered thereby.

FIG. 8 is a side elevation view of the mouse cover of FIG. 1, with a mouse covered thereby.

FIG. 9 is a top plan view of the mouse cover of FIG. 1, with a mouse covered thereby.

FIG. 10 is an exploded top perspective view of a mouse cover in accordance with a second preferred embodiment of the present invention, shown with a mouse.

FIG. 11 is a flow chart showing a preferred method for modifying an external form of a computer mouse.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

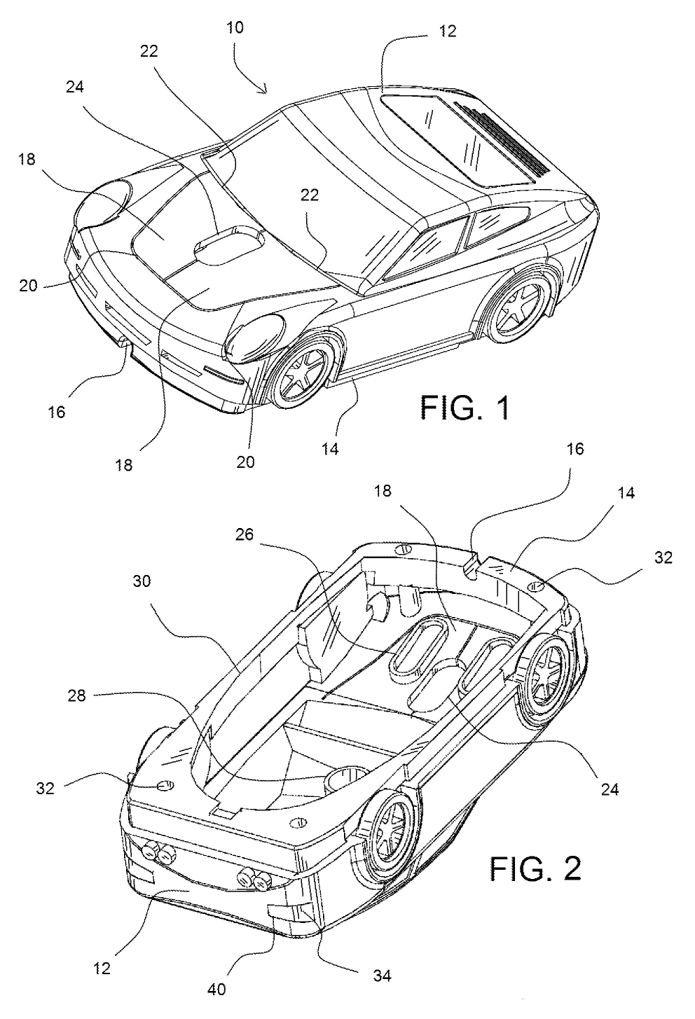

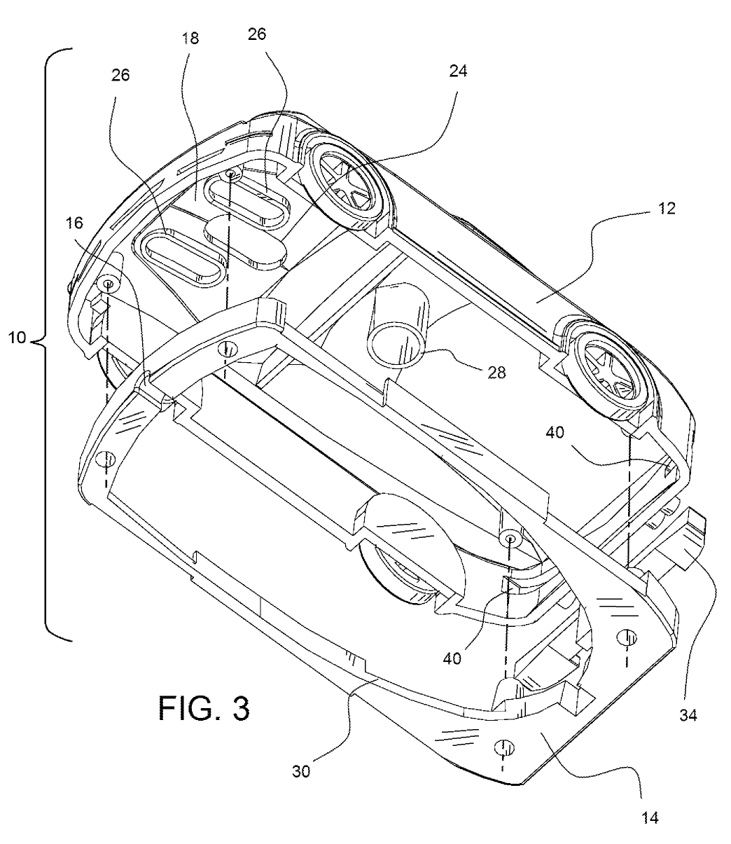

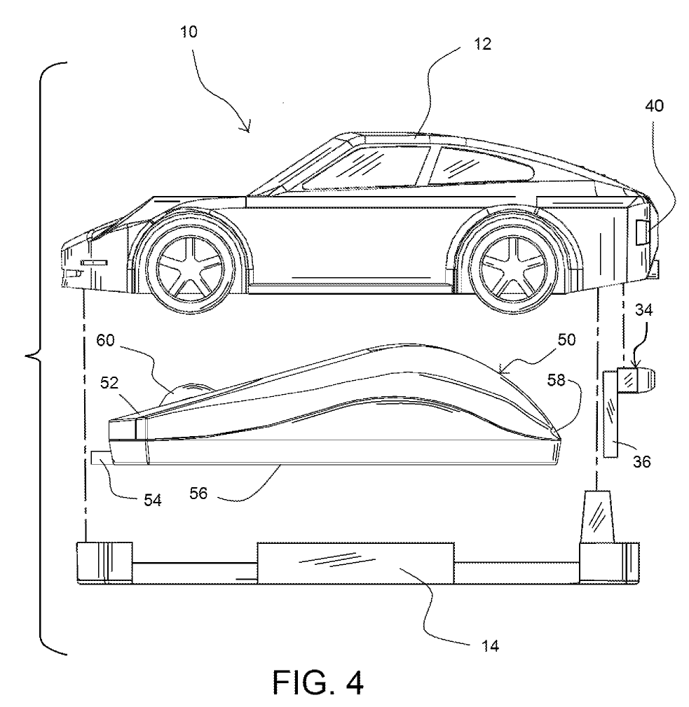

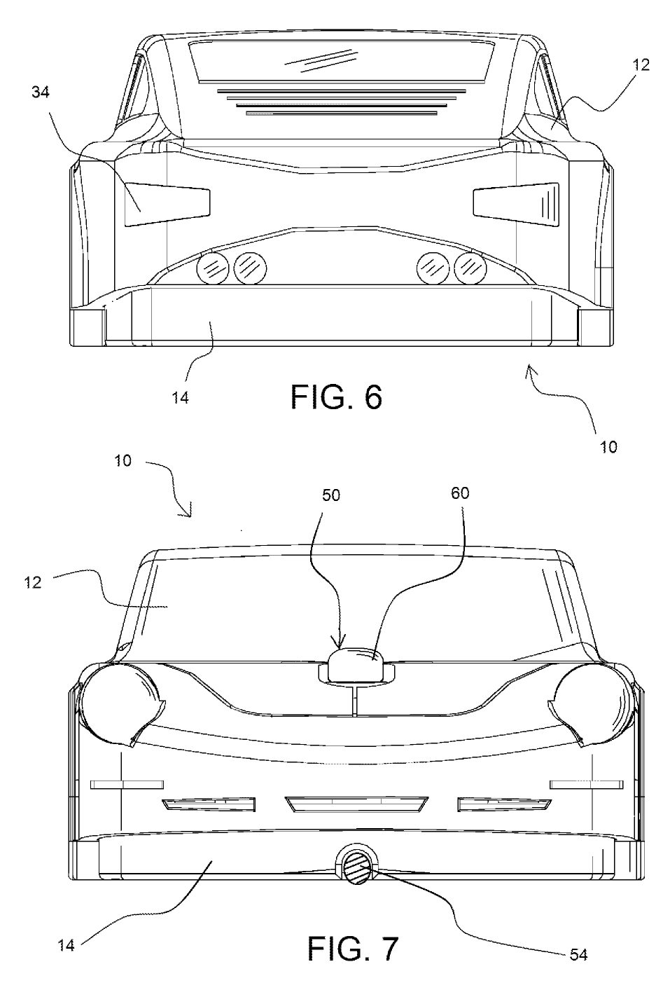

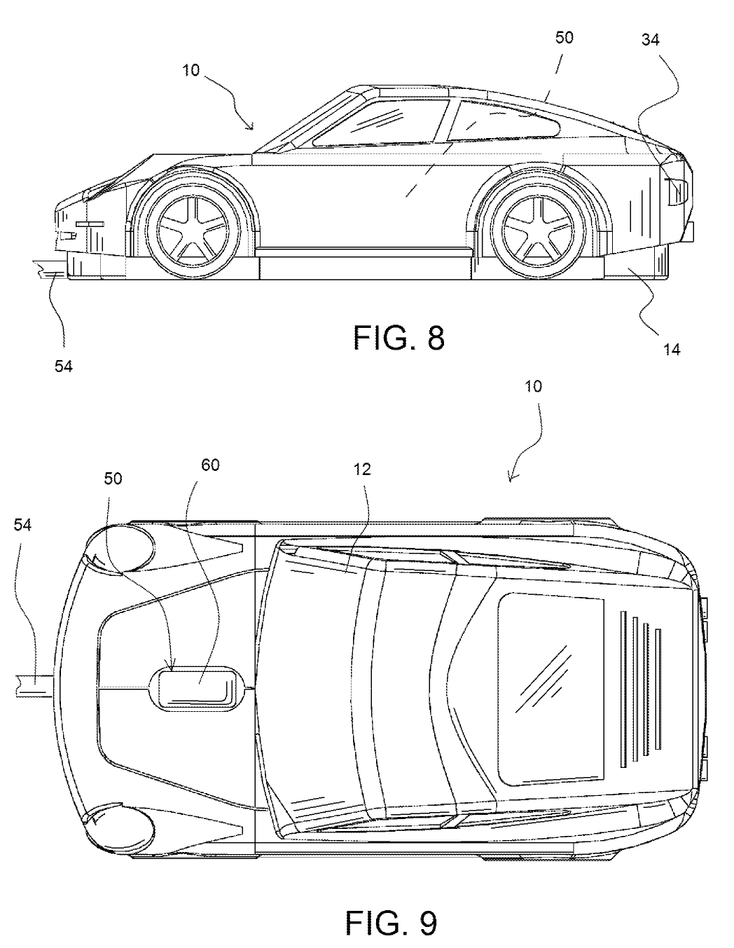

FIGS. 1-9 show a mouse cover 10 according to a first preferred embodiment of the invention. The mouse cover 10 includes a first portion in the form of a shell 12 and a second portion in the form of a chassis 14 for receiving and housing a mouse, for example the computer mouse 50 as shown in FIGS. 4-9. Alternatively, the shell 12 and chassis 14 can be replaced by a single integral portion as discussed later below.

The cover 10 can be configured in any desired form which would allow a mouse such as the computer mouse 50 to be at least partially covered thereby and which permits comfortable manipulation by a hand of a computer user. The cover is preferably generally rigid, although alternatively, the cover can be manufactured in a semi-rigid configuration. The shell 12 and the chassis 14 are preferably formed using one or more types of suitable polymeric material, for example polyethylene, polypropylene, polystyrene, polyvinyl chloride or ABS, and using a suitable plastics forming process, such as injection molding, blow molding or thermoforming. Alternatively, the shell 12 and chassis 14 can be formed from any desired material or materials using any suitable process or processes.

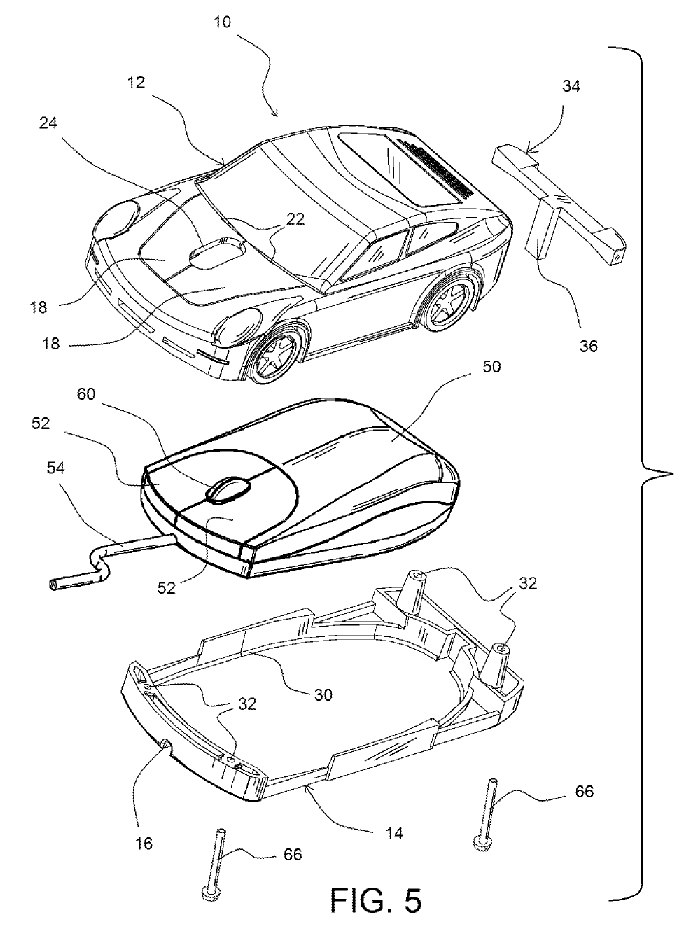

Referring to FIGS. 4 and 5, the mouse 50 is preferably positioned between the shell 12 and chassis 14 during installation of the cover 10. If the mouse 50 includes a signal wire 54, the wire 54 is arranged through a slot 16 in the chassis 14. Lips 30 located on the chassis 14 form an area for making contact with a portion of a bottom surface 56 of the mouse 50 to retain the mouse 50 securely between the shell 12 and the chassis 14. The lips 30 are preferably of sufficiently small dimension such that the bottom surface of the mouse is not raised any significant distance, or depending on the mouse configuration, no distance at all from a surface on which the mouse 50 is placed. While the present invention is especially suited for use with an optical type mouse, whether the mouse 50 utilizes an optical or mechanical sensor for tracking, the functionality of the mouse 50 will not be affected. Further, while the lips 30 are shown as integral with the chassis 14, one skilled in the art will recognize that the lips can alternatively include one or more suitable non-integral portions.

Screws 66 are provided to pass through apertures 32 to connect the shell 12 to the chassis 14 to secure the mouse 50 within the cover 10. Alternatively, any suitable removable or permanent fastening method can be used to assemble the cover 10. For example, portions of the shell 12 can be provided which removably or permanently connect with cooperating portions of the chassis 14 to produce a snap-on connection requiring no external hardware. Alternatively, the cover 10 can be formed with the shell 12 and the chassis 14 as a single integral unit including one or more elastic locking portions, such as spring clips, or manually operated latches capable of retaining a mouse when the cover is placed over the mouse.

Referring to FIGS. 1-9, the shell 12 includes touch areas 18 which correspond to mouse control portions, for example buttons 52 on a top surface of the mouse 50. When the touch areas 18 are depressed, the buttons 52 of the mouse 50 covered by the cover 10 are actuated. The touch areas 18 are preferably integrated with the shell 12 and include circuitous cut-outs 20 allowing each touch area 18 to pivot about a leading edge 22. The leading edges 22 act as spring hinges which bias the touch areas 18 to positions substantially flush with adjacent portions of the shell 12. Alternatively, the long circuitous cutouts 20 could be replaced with one or more short linear or curving cutouts to permit movement of the touch areas 18. Moreover, if the material forming the shell 12 is sufficiently thin and pliable, the shell 12 can alternatively be provided without cutouts. Alternatively, the shell 12 can be provided without any material in the touch areas, leaving the mouse buttons 52 fully exposed for actuation. While only two touch areas 18 are shown, additional touch areas can alternatively be provided to accommodate additional mouse controls, for example mouse buttons positioned on side surfaces of the mouse.

An elongated access aperture 24 is positioned on the shell 12 adjacent to the touch areas 18 preferably to allow a user access to actuate a scroll wheel 60 of the mouse 50 or another type of mouse control portion. The access aperture 24 can be positioned in an alternative manner depending on the mouse configuration. Also, other types of apertures can alternatively be provided in varied locations on the shell 12 to afford access to mouse control portions other than the typical scroll wheel.

Depending on the shape of the mouse 50, the inside surface of the touch areas 18 may include spacers 26 ensuring contact of the touch areas 18 with the mouse buttons 52. Further, structure such as a protrusion 28, is preferably provided on the inside surface of the shell 12, if required, to allow good contact between the shell 12 and the mouse 50 to prevent flexing or distorting of the cover 10. The spacers 26 and protrusion 28 can be formed integrally with the shell 12 or attached to the shell after forming, and they can be formed of any suitable material including, for example, foam, wood, cloth or any suitable polymeric material. Also, different sizes and shapes of the spacers 26 and the protrusion 28 can alternatively be provided to accommodate different mice.

A lens 34 is connected to the shell 12 to channel light emitted from an indicia 58 on the mouse 50 through apertures 40. The lens 34 is preferably formed of a transparent or translucent polymeric material and is snap fit or adhered to the shell 12 of the cover 10. Alternatively, the lens 34 can be integrally formed with the shell 12, for example during a molding or thermoforming process. The lens 34 preferably includes an extending member 36 for channeling light, through reflection and/or refraction, from the indicia 58 through the lens 34. Accordingly, a user can view light signals from the mouse when the cover 10 is installed. While the lens 34 is shown to direct light to a rear portion of the cover 10 from the indicia 58 located on a rear portion of the mouse 50, alternatively, other light channeling devices or windows can be provided to allow light emitted from indicia positioned at any suitable location on a mouse to be viewed by a user at any suitable location on the cover 10, including for example the front, top, or sides of the cover 10. Such devices may include suitable transparent or translucent lenses and/or fiber optics.

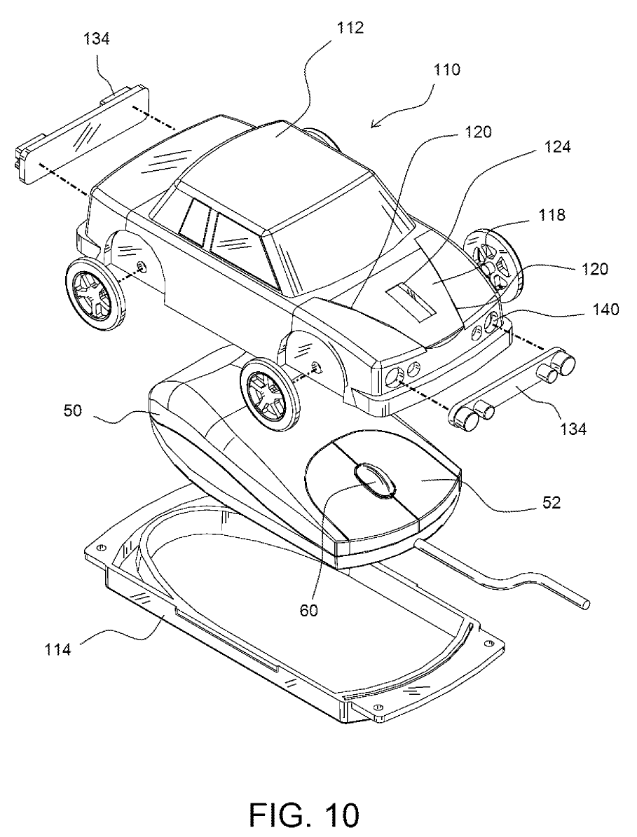

Referring to FIG. 10, a mouse cover 110 according to a second preferred embodiment of the present invention is shown. The mouse cover 110 covers a mouse 50 in a similar manner to the mouse cover 10 of the first preferred embodiment. The mouse cover 110 includes a shell 112 for connection with a chassis 114. Cutouts 120 are provided to allow free movement of a touch area 118, which corresponds to the buttons 52 on the top surface of the mouse 50. An aperture 124 is provided in the shell 112 to allow a user to actuate the scroll wheel 60 of the mouse 50. Lenses 134 are mounted within corresponding apertures 140 on the shell 112 to permit light emitted from indicia on the mouse 50 to be viewed by a user.

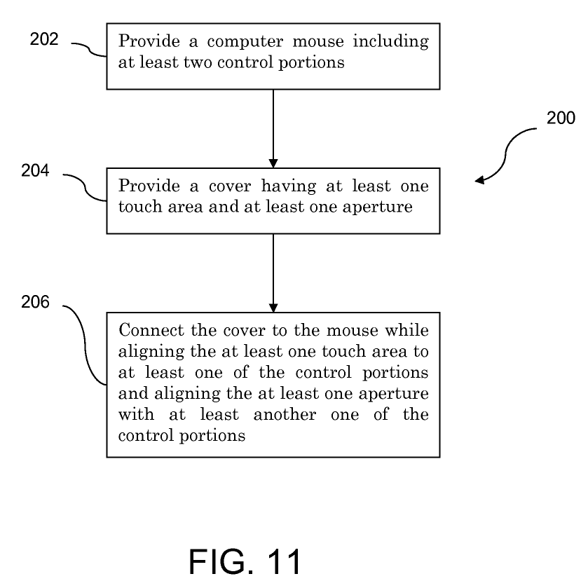

Referring to FIG. 11, a method 200 for modifying an external form of a computer mouse is described. The method includes providing a computer mouse with at least two control portions (step 202) and providing a cover having at least one touch area and at least one access aperture (step 204). The cover is connected to the mouse. The at least one touch area is aligned to at least one of the control portions, and the at least one access aperture is aligned with at least another one of the control portions (step 206).

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A cover for covering a computer mouse, the cover comprising:
a chassis which defines a mouse receiving area; and
a shell connected to the chassis further defining the mouse receiving area, the shell comprising at least one moveable touch area for contacting at least a first control portion of the computer mouse and at least one aperture for allowing access to at least a second control portion of the computer mouse.

2. The cover of claim 1, wherein the shell is removably connected to the chassis.

3. The cover of claim 1, wherein the at least one moveable touch area comprises a first moveable touch area and a second moveable touch area, and wherein the at least one aperture is positioned between the first moveable touch area and the second moveable touch area.

4. The cover of claim 1, wherein the chassis and the shell comprise a polymeric material, and wherein the at least one moveable touch area comprises a cutout for permitting motion of the at least one moveable touch area relative to the shell.

5. The cover of claim 1, wherein the at least one moveable touch area comprises at least one circuitous cut-out.

6. The cover of claim 1, wherein the at least one moveable touch area comprises at least one circuitous cut-out forming a leading edge, wherein the at least one moveable touch area is pivotable about the leading edge.

7. The cover of claim 6, wherein the leading edge biases the at least one moveable touch area to a position substantially flush with adjacent portions of the shell.

8. The cover of claim 1, wherein the chassis comprises at least one lip for retaining the computer mouse within the mouse receiving area.

9. The cover of claim 1, further comprising at least one lens for channeling light from a lighted indicia on the computer mouse to position remote from the lighted indicia on the computer mouse.

10. A combination mouse cover and computer mouse comprising:
a computer mouse including at least two control portions; and
a mouse cover connected to the computer mouse which at least partially conceals the computer mouse, the mouse cover comprising at least one moveable touch area in contact with at least one of the control portions and at least one aperture for allowing access to at least another one of the control portions.

11. The combination mouse cover and computer mouse of claim 10, wherein the at least two control portions comprise a first mouse button, a second mouse button and a scroll wheel positioned between the first mouse button and the second mouse button, and wherein the at least one moveable touch area comprises a first moveable touch area in movable contact with the first mouse button and a second moveable touch area in movable contact with the second mouse button, and wherein the scroll wheel protrudes through the at least one aperture of the mouse cover.

12. The combination mouse cover and computer mouse of claim 10, wherein the at least one moveable touch area comprises a cutout for facilitating motion of the at least one moveable touch area.

13. The combination mouse cover and computer mouse of claim 10, wherein the at least one moveable touch area comprises at least one circuitous cut-out forming a leading edge, wherein the at least one moveable touch area is pivotable about the leading edge, and wherein the leading edge biases the at least one moveable touch area to a position substantially flush with adjacent portions of the shell and in contact with the at least one of the control portions.

14. The combination mouse cover and computer mouse of claim 10, wherein the at least one moveable touch area comprises at least one spacer for contact with the at least one of the control portions.

15. The combination mouse cover and computer mouse of claim 10, wherein the computer mouse further comprises a lighted indicia, and wherein the mouse cover further comprises at least one lens for channeling light from the lighted indicia to a position remote from the lighted indicia on the computer mouse.

16. A method for modifying an external form of a computer mouse, the method comprising:
providing a computer mouse with at least two control portions;
providing a cover having at least one touch area and at least one access aperture; and
connecting the cover to the mouse, wherein the at least one touch area is aligned to at least one of the control portions, and wherein the at least one access aperture is aligned to at least another one of the control portions.

17. The method of claim 16, further comprising:
providing the computer mouse with at least one mouse button and a scroll wheel;
contacting the at least one touch area with the at least one mouse button; and
positioning the access aperture over the scroll wheel to permit the scroll wheel to pass through the aperture.

18. The method of claim 16, further comprising:
providing the computer mouse with at least two mouse buttons and a scroll wheel; and
providing the cover with at least one circuitous cut-out forming a leading edge, wherein the at least one moveable touch area is pivotable about the leading edge, and wherein the leading edge biases the at least one moveable touch area to a position in contact with at least one of the at least two mouse buttons.
